(19) United States
(12) Patent Application Publication
(10) Pub. No.: US 2006/0200993 A1
(43) Pub. Date: Sep. 14, 2006

(54) Serving claw device

(76) Inventor: Brett Di Paolo, Brampton (CA)

Correspondence Address: GEORGE A. ROLSTON, 45 SHEPPARD AVE EAST, SUITE 900, TORONTO, ON, M2N5W9, CA

(21) Appl. No.: 11/371,090

(22) Filed: Mar. 9, 2006

Related U.S. Application Data
(60) Provisional application No. 60/659,420, filed on Mar. 9, 2005.

(51) Int. Cl. B26B 11/00

(52) U.S. Cl. 30/129

(57) ABSTRACT

A fork device for serving food including a tubular elongate body having a first end and an opposite second end, the tubular elongate body having a handle member generally proximate to the first end, a fork member secured to the second end of the tubular elongate body for engaging the food, a spring biasing means disposed within the tubular elongate body and passing through at least a portion of the handle member and a serving member slidably coupled to the fork member. The serving member being operatively connected to the spring biasing means so that operation of the spring biasing means moves the serving member from a first position to a second position, wherein in the first position the serving member is substantially retracted within the tubular elongate body and is engaged by the spring biasing means, and wherein in the second position the operation of the spring biasing means extends the serving member longitudinally relative to the tubular elongate body.

### PRIOR APPLICATION

This application claims the benefit of U.S. Provisional Application Ser. No. 60/659,420, filed Mar. 9, 2005, entitled SERVING CLAW DEVICE.

### FIELD OF THE INVENTION

The invention relates to a cooking utensil device, and more particularly to a serving fork device for engaging and disengaging food.

### BACKGROUND OF THE INVENTION

Outdoor barbequing is an increasingly popular cooking technique which produces foods, such as steaks, chicken and vegetables, having unique flavors and textures which cannot be easily duplicated in a traditional kitchen. Transferring the foods cooked on a barbeque directly to the plates of the guests using a spatula or tongs commonly results in the foods being accidentally dropped on the ground or the guests themselves. In order to have greater control over the transfer of the foods, many barbeque users wear oven mittens or similar apparel to manually grasp and place the food on the guest's plate. Manually transferring the food can be very dangerous, and may result in the barbeque user accidentally burning their hand, wrist or arm on the food or the barbeque.

Accordingly, there is a need for a fork device for use when barbequing that enables the safe transfer of cooked food from the barbeque. There is a further need for a fork device that is positionable between a first position and a second position, whereby in the first position the food is engaged on the fork member, and whereby in the second position the food is disengaged from the fork member.

### SUMMARY OF THE INVENTION

The present invention is directed to a fork device for serving food including a tubular elongate body having a first end and an opposite second end, the tubular elongate body having a handle member generally proximate to the first end, a fork member secured to the second end of the tubular elongate body for engaging the food, a spring biasing means disposed within the tubular elongate body and passing through at least a portion of the handle member, and a serving member slidably coupled to the fork member. The serving member being operatively connected to the spring biasing means so that operation of the spring biasing means moves the serving member from a first position to a second position, wherein in the first position the serving member is substantially retracted within the tubular elongate body and is engaged by the spring biasing means, and wherein in the second position the operation of the spring biasing means extends the serving member longitudinally relative to the tubular elongate body. The tubular elongate body has a generally oval cross-section.

The serving member has a longitudinal groove proximate to the first end of the tubular elongate body, the groove being adapted to slideably receive at least a portion of the spring biasing means. The groove includes an enlarged aperture which engages with at least a portion of the spring biasing means to prevent the serving member from moving into the second position.

The handle member includes a hole proximate to the enlarged aperture on the groove, the hole being configured to operatively receive the spring biasing means therein. The spring biasing means includes a button, whereby the entry of the button into the hole disengages the spring biasing means from the enlarged aperture and extends the serving member longitudinally relative to the tubular elongate body. The spring biasing means includes a button, the button being resiliently urged in a radially outward direction into the hole, whereby the entry of the button into the hole prevents the movement of the serving member from the first position.

The serving member including a flange portion for contacting with the food, the flange portion extending generally perpendicularly from the serving member. In the first position the food is engaged on the fork member and the serving member is partially retracted within the tubular elongate body. In the second position the food is disengaged from the fork member and the serving member is partially extended from the tubular elongate body.

The fork member has one or more sharpened tines for engaging the food. Each of the one or more tines is formed with an inner edge and an outer edge, and a plurality of sharpened teeth extend from and generally along the outer edge of each of the one or more tines.

The first end of the tubular elongate body is provided with a heat-resistant sleeve. The tubular elongate body, the serving member, and the fork member are made of a metallic material. The tubular elongate body, the serving member and the fork member are made of polypropylene. The first end of the tubular elongate body is provided with a hook means.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a perspective view of a fork device made in accordance with a preferred embodiment of the invention;

FIG. 2 is a perspective view of the fork device of FIG. 1 with the serving member shown in a first position;

FIG. 3 is a perspective view of the fork device of FIG. 1 with the serving member shown in a second position;

FIG. 4 is a side elevation view of the spring biasing means of the fork device of FIG. 1;

FIG. 5 is a side, cross-section view of the spring biasing means of the fork device of FIG. 1 disposed within the tubular elongate member and slidably engaged with the serving member in a first position;

FIG. 6 is a plan view of the serving member of the fork device of FIG. 1; and

FIG. 7 is side, cross-sectional view of the spring biasing means of the fork device of FIG. 1 disposed within the tubular elongate member and slidably engaged with the serving member in a second position;

### DETAILED DESCRIPTION OF THE INVENTION

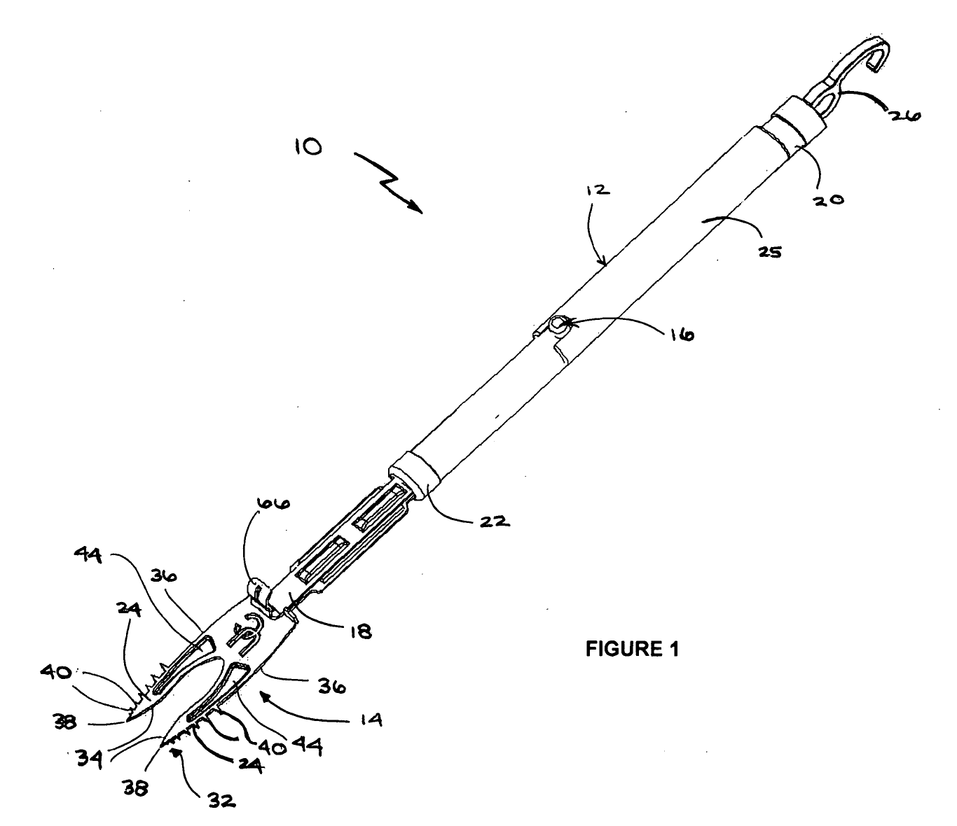

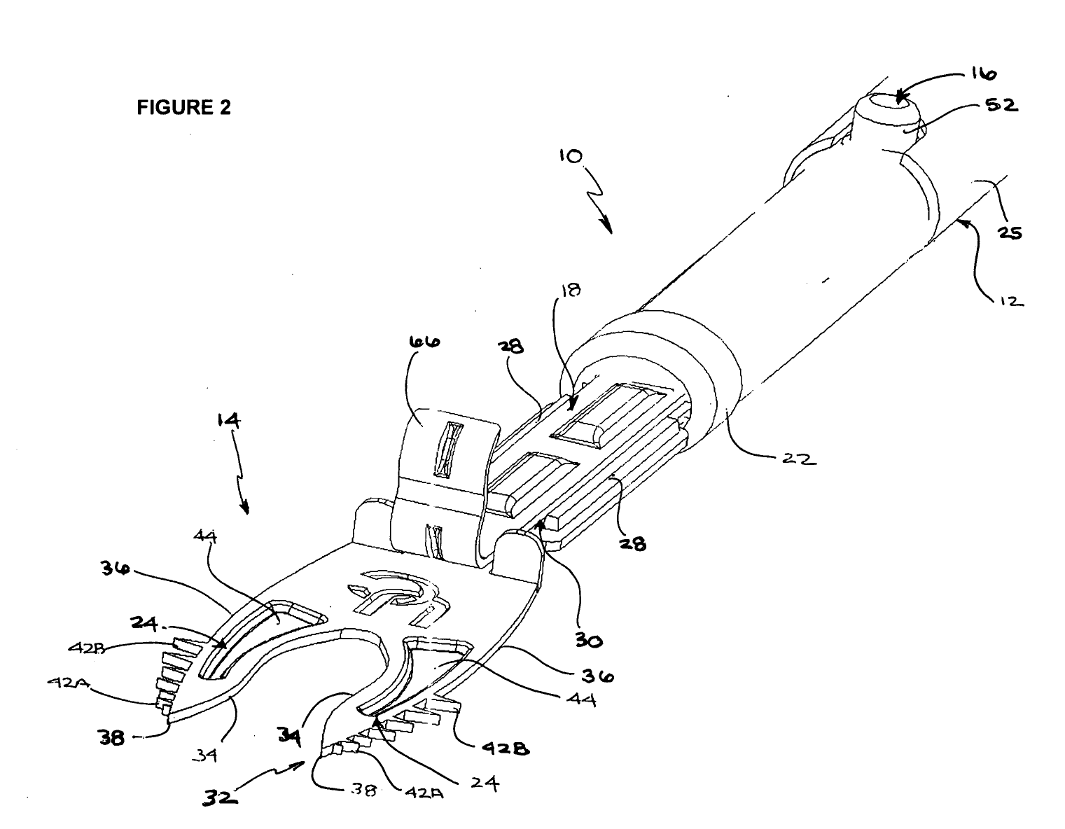

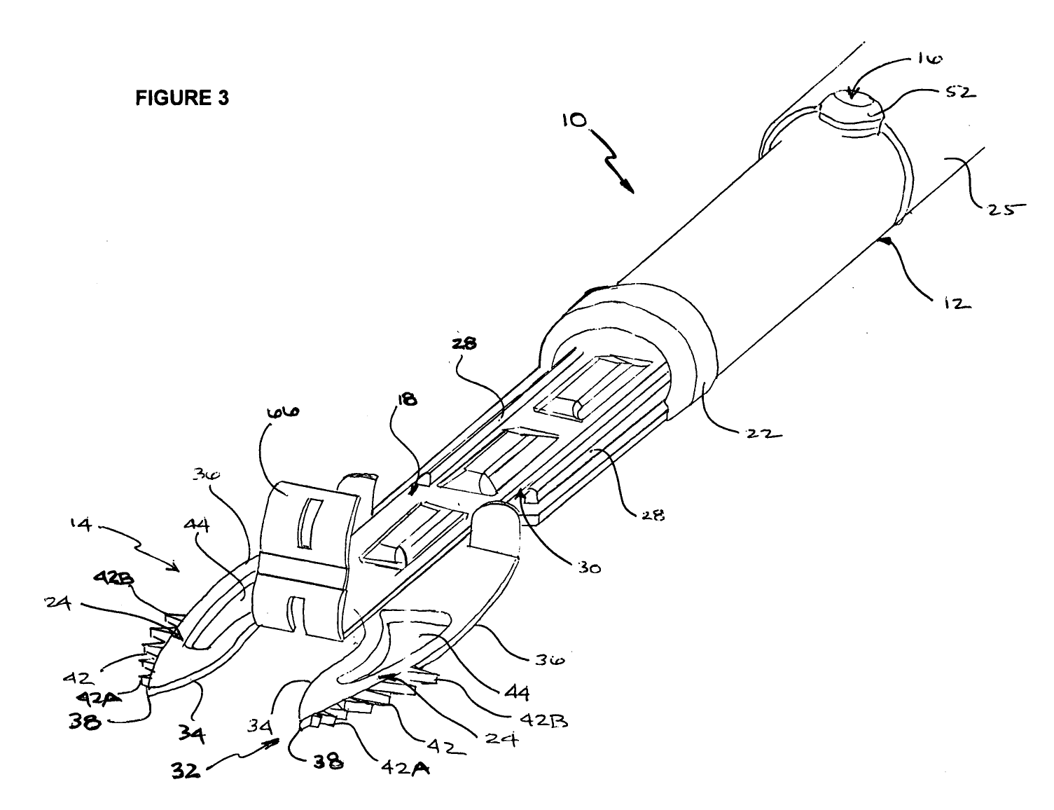

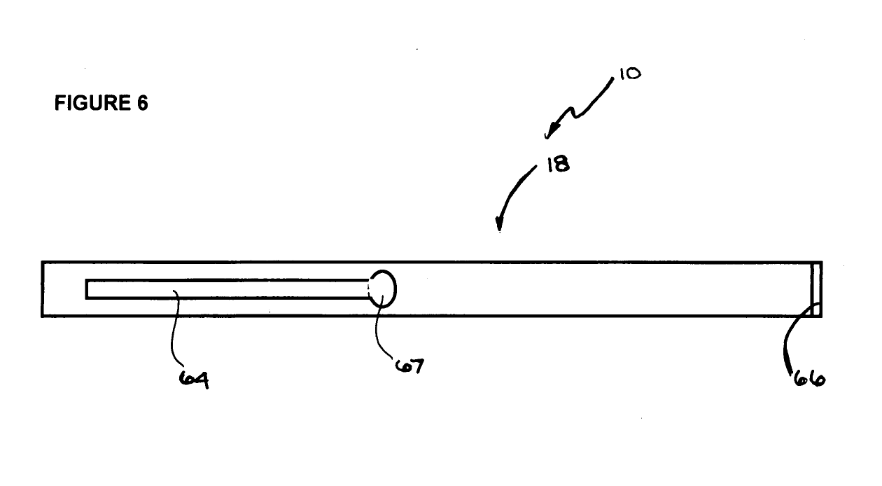

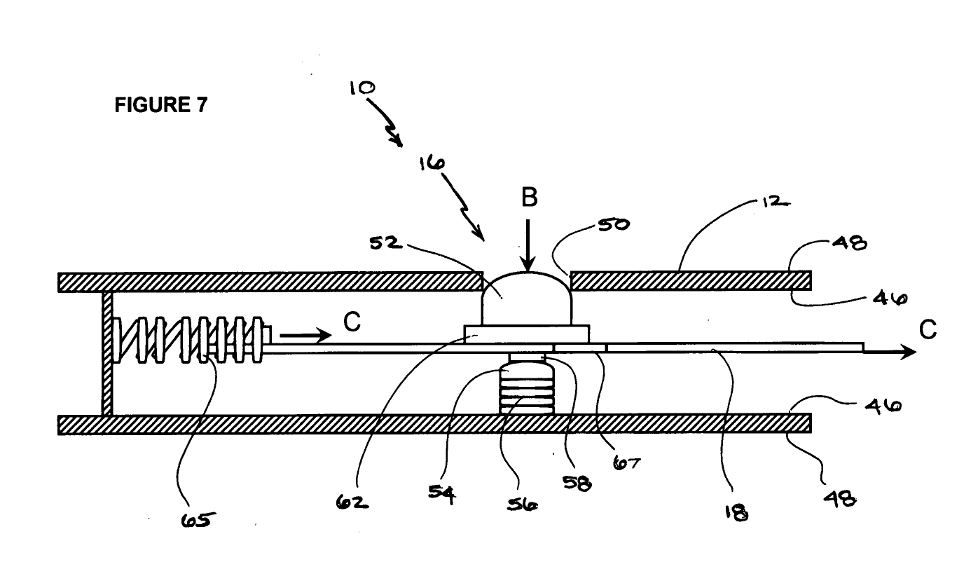

Reference is made to FIGS. 1-7 which illustrate a fork device 10 for serving food made in accordance with a preferred embodiment of the present invention. Fork device 10 has a tubular elongate body 12, a fork member 14, a spring biasing means 16, and a serving member 18. By this design, the fork device 10 is positionable between a first position and a second position. When the fork device 10 is positioned in the first position as shown in FIG. 2, the food is engaged on the fork member 14 and the serving member 18 is partially retracted within the tubular elongate body 12. In the second position shown in FIG. 3, the serving member 18 moves into a partially extended position from the tubular elongate body 12 and disengages the food from the fork member 14.

Referring the FIGS. 1, the elongate body 12 has a first end 20 and an opposite second end 22, and a handle member 24 provided proximate to the first end 20 thereof. The first end of the elongate body 12 may have an optional hook means 26 to allow the fork device 10 to be attached to a barbeque or the barbeque user's belt. The elongate body 12 is shown to have a generally oval shaped cross-section. While the elongate body 12 is advantageously oval-shaped to ergonomically conform to the barbeque user's hands, it should be understood that the elongate body 12 may have any suitable cross-section.

Referring to FIGS. 1, 2 and 3, the fork member 14 is secured to the second end 22 of the tubular elongate body 12. The fork member 14 includes a pair of spaced guides 28 which define a channel 30 for slidably receiving the serving member 18. A distal end 32 of the fork member 14 is formed one or more sharpened tines 24 for engaging food on a barbeque. Each of the one or more tines 24 is formed with an inner edge 34 and an outer edge 36 that intersect at a point 38. The inner edges 34 intersect to form a generally U-shape. The outer edge 36 of each of the tines 24 is provided with a plurality of sharpened teeth 40 which extend from and partially along the outer edge 36 from the point 40 of tine 24. The teeth 42 are generally triangular-shaped and are adapted to facilitate the engaging of the food on the fork device 10. Preferably, the teeth 42 are graduated along the outer edge 36 of the tine 24, whereby smaller teeth 42A are provided adjacent to the point 30 and larger teeth 42B are provided further along the outer edge 36. By this design, the graduated teeth 42 forcibly engage with the food so as to ensure that the food remains securely engaged on the fork member as it is being removed from the barbeque. As shown in FIG. 3, each of the one or more tines 24 may be provided with one or more recesses or apertures 44 which reduce the amount of force that is required to engage the fork member 14 into the food on the barbeque.

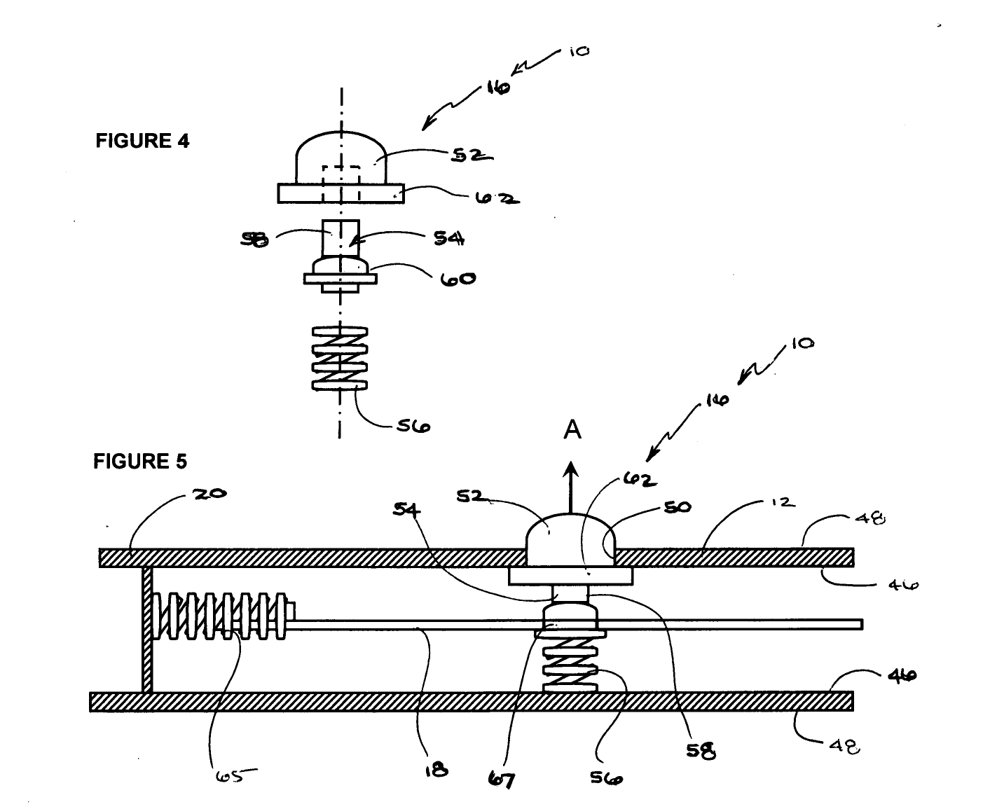

Referring to FIGS. 4 and 5, the spring biasing means 16 is generally disposed within the tubular elongate body 12. The tubular elongate body 12 includes an inner surface 46 and an outer surface 48. A hole 50 is provided through the inner and outer surfaces 46 and 48 of the tubular elongate body 12 and the handle member 24 which operatively receives the spring biasing means 16. The spring biasing means 16 includes a button 52, a shaft 54 and a biasing spring 56, whereby the movement of the button 52 within the hole 50 causes the shaft 54 to engage and disengage from the serving member 18.

The shaft 45 has an insert portion 58 coupled to the button 52 and a girth portion 60 that has a larger dimension than the insert portion 58. The positioning of the button 52 within the hole 50 also limits the rotational movement of the serving member 18 relative to the tubular elongate body 12. As shown in FIGS. 4 and 5, the button 52 has a seat portion 62 which partially retains the button 52 against the inner surface 46 of the tubular elongate body 12 and maintains the button 52 within the hole 50. The biasing spring 56 is coupled to the interior surface 46 of the tubular elongate body 12 and is designed to resiliently urge the shaft 54 and the button 52 into the hole 50 in a radial direction A.

Referring to FIGS. 4, 5, 6 and 7, the serving member 18 is slidably coupled to the fork member 14, and is operatively connected to the spring biasing means 16. Serving member 18 has a longitudinal groove 64 and a positioning spring 65 which is coupled to the first end 20 of the tubular elongate body 12 when the serving member 18 is received therein. The serving member 18 has a flange portion 66 extending generally perpendicularly from the serving member 18 for contacting with the food engaged on the fork member. The groove 64 being adapted to slideably receive the shaft 54 of the spring biasing means 16. The groove 64 includes an enlarged aperture 67 which is designed to engage with the girth portion 60 of the shaft 54 when the serving member is positioned in the first position (as shown in FIG. 5). The serving member 18 may be moved into the second position by pressing the button 52 in the direction B against the action of the biasing spring 56 until the girth portion 60 disengages from the enlarged aperture 66. When the girth portion 60 becomes disengaged from the enlarged aperture 67, the positioning spring 65 urges or extends the serving member 18 longitudinally along the tubular elongate member 12 in the direction C. The movement of the serving member 18 into the second position causes the flange portion 66 to force the food from the fork member 14.

To return the serving member 18 to the first, engaged position, the barbeque user simply forcibly inserts the fork member into the food. The flange portion 66 of the serving member 18 contacts the food which causes the serving member 18 itself to partially retract into the tubular elongate body 12 against the action of the positioning spring 65. When the enlarged aperture 67 is generally in alignment with the hole 50, the girth portion 60 of the spring biasing means 16 will be urged in the direction A into the enlarged aperture 67, thereby retaining the serving member in the engaged first position. To serve the food to a guest, the barbeque user presses the button 52 into the hole 50 formed in the tubular elongate body 12, thereby disengaging the girth portion of the spring biasing means 16 from the enlarged aperture 67 of the serving member 18 and urgingly extending the serving member 18 along the tubular elongate body 12.

In a further embodiment of the present invention, the handle member 24 of the tubular elongate body 12 may be provided with a heat-resistant sleeve to minimize the transmission of heat from the fork device 10 to the hand of the barbeque user. The heat-resistant sleeve may be made of any suitable material, such as, for example, rubber or polypropylene. It should be understood that the tubular elongate member 12, the fork member 14 and/or the serving member 18 may be manufactured from any suitable materials known by persons skilled in the art. For example, the tubular elongate member 12, the fork member 14 and/or the serving member 18 may be manufactured from a metallic material, such as stainless steel or any steel material that may be used to engage on a barbeque. It should be understood that the length of the tubular elongate body 12 and fork member 14 together should be sufficient to ensure that the hands and arms of the barbeque user are a safe distance away from the hot surface of the barbeque grill.

The present invention has been described with regard to specific embodiments. However, it will obvious to persons skilled in the art that a number of variants and modifications can be made without departing from the scope and spirit of the invention, the scope of which is defined in the appended claims.

1. A fork device for serving food, comprising:
a tubular elongate body having a first end and an opposite second end, the tubular elongate body having a handle member generally proximate to the first end;
a fork member secured to the second end of the tubular elongate body for engaging the food;
a spring biasing means generally disposed within the tubular elongate body and passing through at least a portion of the handle member; and
a serving member slidably coupled to the fork member, the serving member being operatively connected to the spring biasing means so that operation of the spring biasing means moves the serving member from a first position to a second position, wherein in the first position the serving member is substantially retracted within the tubular elongate body and is engaged by the spring biasing means, and wherein in the second position the operation of the spring biasing means extends the serving member longitudinally relative to the tubular elongate body.

2. The fork device as claimed in claim 1, wherein the tubular elongate body has a generally oval cross-section.

3. The fork device as claimed in claim 1, wherein the serving member has a longitudinal groove proximate to the first end of the tubular elongate body, the groove being adapted to slideably receive at least a portion of the spring biasing means.

4. The fork device as claimed in claim 3, wherein the groove includes an enlarged aperture which engages with at least a portion of the spring biasing means to prevent the serving member from moving into the second position.

5. The fork device as claimed in claim 4, wherein the handle member includes a hole proximate to the enlarged aperture on the groove, the hole being configured to operatively receive the spring biasing means therein.

6. The fork device as claimed in claim 5, wherein the spring biasing means includes a button, whereby the entry of the button into the hole disengages the spring biasing means from the enlarged aperture and extends the serving member longitudinally relative to the tubular elongate body.

7. The fork device as claimed in claim 5, wherein the spring biasing means includes a button, the button being resiliently urged in a radially outward direction into the hole, whereby the entry of the button into the hole prevents the movement of the serving member from the first position.

8. The fork device as claimed in claim 1, wherein the serving member including a flange portion for contacting with the food, the flange portion extending generally perpendicularly from the serving member.

9. The fork device as claimed in claim 1, wherein in the first position the food is engaged on the fork member and the serving member is partially retracted within the tubular elongate body.

10. The fork device as claimed in claim 1, wherein in the second position the food is disengaged from the fork member and the serving member is partially extended from the tubular elongate body.

11. The fork device as claimed in claim 1, wherein the fork member has one or more sharpened tines for engaging the food.

12. The fork device as claimed in claim 11, wherein the each of the one or more tines is formed with an inner edge and an outer edge, and wherein a plurality of sharpened teeth extend from and generally along the outer edge of each of the one or more tines.

13. The fork device as claimed in claim 1, wherein the handle member of the tubular elongate body is provided with a heat-resistant sleeve.

14. The fork device as claimed in claim 1, wherein the tubular elongate body, the serving member, and the fork member are made of a metallic material.

15. The fork device as claimed in claim 1, wherein the tubular elongate body, the serving member and the fork member are made of polypropylene.

16. The fork device as claimed in claim 1, wherein the first end of the tubular elongate body is provided with a hook means.
